(19) United States
(12) Patent Application Publication
(10) Pub. No.: US 2007/0041392 A1
(43) Pub. Date: Feb. 22, 2007

(54) Adaptive message buffering

(76) Inventors: Aaron Kunze, Portland, OR (US); Stephen D. Goglia, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/209,407

(22) Filed: Aug. 22, 2005

(51) Int. Cl. H04L 12/28

(52) U.S. Cl. 370/412

(57) ABSTRACT

In general, in one aspect, the disclosure describes a method that includes accessing at least one statistic descriptive of message operations performed on multiple-buffer messages, where the buffers have a predetermined, different buffer sizes. The method also includes changing the predetermined sizes of the buffers for subsequently created messages based on the at least one statistic descriptive of message operations.

### BACKGROUND

A wide variety of computing environments use message passing to communicate. For example, message passing may occur between processors, processor threads, operating system processes, devices, and so forth. The basic operations performed on messages are often the same across many different applications. Thus, it is common for the handling of messages to be abstracted into a messaging software library that provides software interfaces for common message manipulating tasks. For example, a messaging library may expose interfaces for creating and destroying messages, reading from and writing to messages, increasing and decreasing the size of messages, and making copies of messages. While some libraries store a message in a single buffer, other libraries use multiple buffers to store a given message. For example, in a multiple-buffer approach, a single message could be stored across multiple buffers, with the collection of buffers being arranged as a linked list or an array.

### BRIEF DESCRIPTION OF THE DRAWINGS

FIG. 1 is a diagram illustrating adaptation of a message format based on message operation.

FIGS. 2A-2D illustrate statistics descriptive of message operations.

FIG. 3 is a flow-chart of a process to adapt a message format.

### DETAILED DESCRIPTION

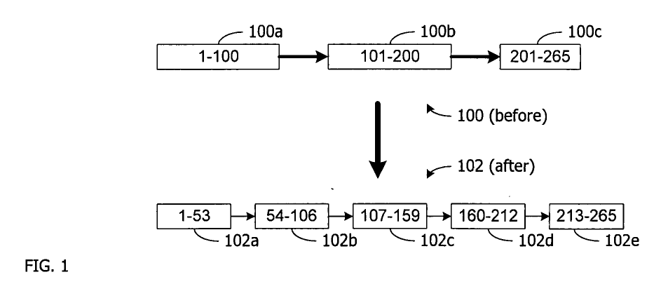

As described above, a messaging library can use multiple buffers to store messages. For example, as shown in FIG. 1, a message 100 is stored as a linked list of buffers 100a-100c. In this particular example, the links between the buffers 100a-100c occur between bytes 100 and 101 and bytes 200 and 201. This particular set of default buffer sizes may not, however, be efficient for every application. For example, a network application may extract individual ATM (Asynchronous Transfer Mode) cells from Ethernet frames for forwarding. Since ATM cells have a fixed size of 53-bytes, a multi-buffer message format 102 featuring 53-byte message buffers may offer more efficient message operations than format 100. That is, the task of extracting a given ATM cell is simply a matter of removing a cell's buffer from the linked list or splitting the message at the appropriate link instead of the more expensive operation of splitting a monolithic buffer in two. However, there are trade-offs with any message format. For example, while format 102 makes splitting the message into ATM cells more efficient, the format 102 makes it slightly more difficult to read or write the bytes in buffers that are not the first buffer, since one or more links are traversed to do so.

Other applications may benefit from other message formats. For example, a network application that performs IPSec (IP [Internet Protocol] Security Protocol) may insert an IPSec authentication header between packets' IP headers and payloads. Such an insertion operation may be executed more efficiently if the insertion operation occurs at a buffer link. For example, the messaging library could simply add an additional buffer for the IPSec header into a message's linked list if the message format provides a link between the end of an IP header and the start of the IP payload instead of having the header/payload boundary occur within a buffer.

This disclosure describes a messaging scheme that can dynamically adjust the format (e.g., size and/or number of buffers) used to store messages based on on-going, run-time monitoring of message operations being performed. That is, the messaging library occasionally adjusts the message format to reflect actual operations being performed on messages. The new message format is then used for messages that are created or received by the system thereafter. As an example, in the Ethernet-to-ATM example described above, the system may modify the message format from format 100 to format 102 in FIG. 1. Such a scheme can relieve a designer from trying to guess where a message format should be broken into multiple buffers. Additionally, the scheme may prevent continued use of a message format that may have proven optimal for some applications operating in the past, but are problematic for a current set of running applications.

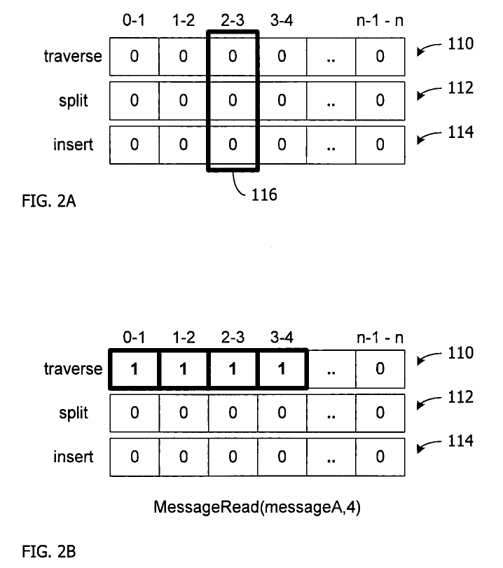

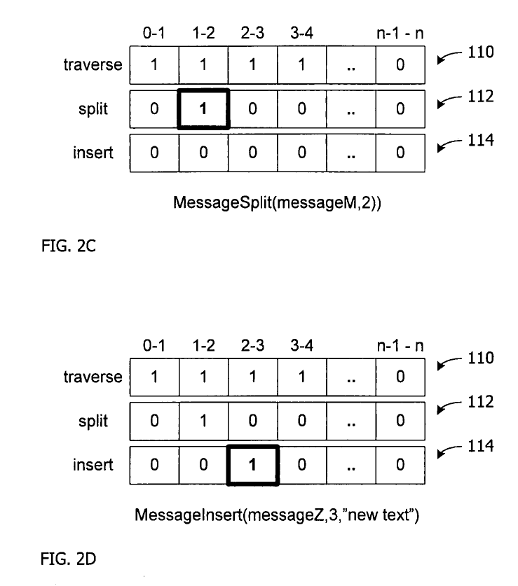

To determine a message format, a messaging library can maintain statistics based on monitored operations. For example, FIGS. 2A-2D illustrate a collection of statistics used to monitor operations that traverse a message (e.g., a read or write of message bytes) 110, split a message 112 at a specified byte, and insert bytes into a message 114 at a specified byte. As shown, these statistics may be kept for each adjacent byte boundary. For example, the third elements 116 of the “traverse” array 110, split array 112, and insert array 114 indicate when a read or write, split, or insert occurs between bytes 2 and 3 of a message.

The statistics shown in FIG. 2A can be updated in response to message operations performed on the same and/or different messages. For example, as illustrated in FIG. 2B, a read of byte-4 of some message “MessageA”, causes the first four elements (bolded) of traverse array 110 to be incremented. That is, even though only byte-4 of MessageA is being retrieved, the messaging library would logically traverse any links between bytes 0-4 to get to byte 4. Similarly, as shown in FIG. 2C, splitting a MessageM into two messages between bytes 1 and 2 increments the corresponding split array value (bolded). Finally, as shown in FIG. 2D, insertion of data before byte-3 of MessageZ increments the corresponding insert array 114 element (bolded).

Maintaining these statistics for every message operation could be computationally expensive. However, since the statistics will only be used in relation to each other, only a sample is necessary. For example, one out of every million read operations could be used to adjust the statistics. It also may be beneficial to weight more recent statistics over less recent statistics. To foster this, an exponential weight moving average algorithm (EWMA) could be used. In such an implementation different sets of statistics can be maintained for different time periods.

While FIGS. 2A-2D depicted a single set of statistics, the message library may permit different message domains that enable multiple message formats to evolve. Additionally, while FIGS. 2A-2D illustrated a sample message library application programmer interface (API) that featured MessageRead, MessageInsert, and MessageSplit operations, the API may expose other operations such as MessageWrite, MessageAllocate, MessageDestroy and so forth. Other APIs providing similar features may use different interface names and/or parameters. Further, the statistics illustrated are merely an example and other statistics may be compiled. Likewise, while FIGS. 2A-2D illustrate arrays storing statistics at byte boundaries other implementations may store the statistics differently.

Occasionally (e.g., periodically) and possibly in the background, the message library may use a cost model to determine a new, potentially more efficient, buffer format. The cost model balances the cost of having a link at a particular boundary against the cost of not having a link at a particular boundary. The former cost comes from the fact that having a link at a boundary causes operations that happen beyond the boundary to traverse the link. The latter cost comes from the fact that not having a link at a boundary makes splitting and inserting at a boundary more expensive. The cost model can include an integer weight to traversing a byte boundary (Cₜᵣₐᵥₑᵣₛₑ), an integer cost to splitting a contiguous buffer (Cₛₚₗᵢₜ), and an integer cost to inserting data into a contiguous buffer (Cᵢₙₛₑᵣₜ). The particular weight values (e.g., Cₜᵣₐᵥₑᵣₛₑ, Cₛₚₗᵢₜ, and Cᵢₙₛₑᵣₜ) are a matter of design choice. For each byte boundary in a message, the total cost of having a link (C) at a particular boundary between byte-x and byte-y is computed using:
C_{(x-y)}=(Cₜᵣₐᵥₑᵣₛₑ*N_{traverse(x-y)})−(Cₛₚₗᵢₜ*N_{split(x-y)})−(Cᵢₙₛₑᵣₜ*N_{insert(x-y)})

where N_{traverse(x-y)}, N_{split(x-y)}, N_{insert(x-y)} are the statistic values for the particular boundary between byte-x and byte-y. If the result, C_{(x-y)}, for a specific message byte-boundary is negative, a link is placed in future messages at the boundary being considered. If the cost is positive, no link is placed at that boundary. As an example, assuming weights of Cₜᵣₐᵥₑᵣₛₑ=5, Cₛₚₗᵢₜ=1 and Cᵢₙₛₑᵣₜ=1, C₍₂₋₃₎=(5*1)−(1*0)−(1*1)=4 based on the statistics shown in FIG. 2D. Thus, since the cost model yields a positive value for the byte-2-to-byte-3 boundary, a revised message format would not split the message into multiple buffers at this point based on the statistics. Of course, other cost models using the same or different parameters may be used.

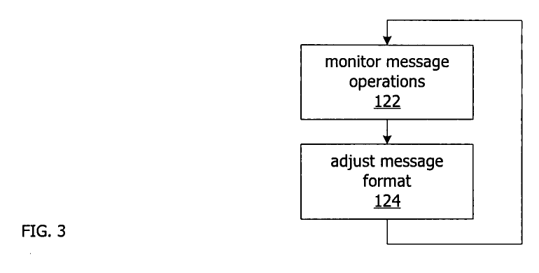

FIG. 3 depicts a flowchart of a process to adapt a message format. As shown, the process monitors 122 and compiles statistics regarding message operations such as the statistics illustrated in FIGS. 2A-2D. Based on the statistics 124 the process can change, during run-time, the format of the buffers for subsequently created messages. The changing may happen at a regular time interval, based on a frequency of memory operations, or after a particular messaging event (e.g., a threshold number of message splits or inserts occur within buffers).

The techniques described above may be implemented in a variety of ways. For example, the techniques may be provided as processor executable instructions disposed on a computer readable medium. For instance, the techniques may be made available to applications as link library software. Alternately, the techniques may be provided in other software and/or hardware implementations.

Other embodiments are within the scope of the following claims.

What is claimed is:

1. A method, comprising:
accessing at least one statistic descriptive of message operations performed on multiple-buffer messages, the buffers in the multiple buffers having a predetermined buffer size, different buffers in the multiple buffers having different sizes; and
changing the predetermined sizes of the buffers during run-time for subsequently created messages based on the at least one statistic descriptive of message operations.

2. The method of claim 1, wherein the operations comprise at least one selected from the following group: (1) a message split operation; and (2) a message insert operation.

3. The method of claim 2, wherein the operations comprise at least one selected from the following group: (1) a message read operation; and (2) a message write operation.

4. The method of claim 1, wherein the message operations comprise message operations initiated via a messaging library Application Programmer Interface (API).

5. The method of claim 1, wherein the buffers comprise buffers in a linked list.

6. The method of claim 1, wherein changing comprises changing based on statistics regarding message splits, message inserts, and message traversals.

7. The method of claim 6, wherein the changing comprises changing based on a non-equal weighting of the message split, message insert, and message traversal statistics.

8. The method of claim 7, wherein the non-equal weighting comprises a weighting based on a time of the messaging operation.

9. The method of claim 1, further comprising updating the statistics for only a subset of message operations.

10. The method of claim 1, further comprising changing the number of buffers based on the at least one statistic.

11. The method of claim 1, wherein the at least one statistic comprises a statistic compiled for byte boundaries of the messages

12. Processor executable instructions disposed on a tangible medium, the instruction comprising instructions for causing a processor to:
access at least one statistic descriptive of message operations performed on multiple-buffer messages, the buffers in the multiple buffers having a predetermined buffer size, different buffers in the multiple buffers having different sizes; and
change the predetermined sizes of the buffers during run-time for subsequently created messages based on the at least one statistic descriptive of message operations.

13. The instructions of claim 12, wherein the operations comprise at least one selected from the following group: (1) a message split operation; and (2) a message insert operation.

14. The instructions of claim 13, wherein the operations comprise at least one selected from the following group: (1) a message read operation; and (2) a message write operation.

15. The instructions of claim 12, wherein the message operations comprise message operations initiated via a messaging library Application Programmer Interface (API).

16. The instructions of claim 12, wherein the instructions to change comprise instructions to change based on statistics regarding message splits, message inserts, and message traversals.

17. The instructions of claim 12, wherein the instructions to change comprise instructions to change based on a non-equal weighting of the at least one statistic.

18. The instructions of claim 17, wherein the non-equal weighting comprises a weighting based on a time of the messaging operation.

19. The instructions of claim 12, further comprising instructions for causing the processor to update the statistics for only a subset of message operations performed.

20. The instructions of claim 12, wherein the at least one statistic comprises a statistic compiled for byte boundaries of the messages.
